(19) United States
(12) Patent Application Publication
(10) Pub. No.: US 2025/0153219 A1
(43) Pub. Date: May 15, 2025

(54) ULTRASONIC VIBRATION SUB-ELEMENT AND ULTRASOUND PROBE

(71) Applicant: Qisda Corporation, Taoyuan City (TW)

(72) Inventors: Fu-Sheng Jiang, Taoyuan City (TW); Yang-Zong Fan, Taoyuan City (TW)

(73) Assignee: Qisda Corporation, Taoyuan City (TW)

(21) Appl. No.: 18/938,296

(22) Filed: Nov. 6, 2024

(30) Foreign Application Priority Data
Nov. 13, 2023 (TW) 112143671

(51) Int. Cl. B06B 1/02

(52) U.S. Cl. CPC B06B 1/0292; B06B 1/0207; B06B 2201/40; B06B 2201/51

(57) ABSTRACT

An ultrasonic vibration sub-element including a substrate, a ground layer, a first insulation layer, a second insulation layer, a first electrode layer, a third insulation layer, and a second electrode layer is provided. The first electrode layer is configured to receive a direct current voltage. The second electrode layer is configured to receive an alternating current signal. Before the ultrasonic vibration sub-element is driven, there is a cavity between the first insulation layer and the second insulation layer. When the ultrasonic vibration sub-element is driven, the first electrode layer receives the direct current voltage and is configured to at least drive the second insulation layer to shrink toward the cavity. The second electrode layer receives the alternating current signal and is configured to at least drive the third insulation layer to vibrate. An ultrasound probe is also provided.

### CROSS-REFERENCE TO RELATED APPLICATION

This application claims the priority benefit of Taiwan application serial no. 112143671, filed on Nov. 13, 2023. The entirety of the above-mentioned patent application is hereby incorporated by reference herein and made a part of this specification.

### BACKGROUND

### Technical Field

The disclosure relates to an ultrasonic vibration sub-element and an ultrasound probe.

### Description of Related Art

The current capacitive micromachined ultrasound transducer (CMUT) requires a bias tee circuit to drive a membrane of the CMUT. The driving manner of the membrane of the CMUT requires the integration of alternating current (AC) and direct current (DC) into electrodes of a vibration film. The DC pre-stretches the membrane of the CMUT, and the AC then vibrates the membrane to generate transmitted ultrasound waves, or the membrane vibrates to generate the AC to return to an ultrasound system. Since an analog-to-digital converter (ADC) of the ultrasound system cannot handle high DC voltage levels (for example, 200V), it is necessary to use a capacitor with sufficient withstand voltage to filter the DC to prevent burning the ADC of the system. In addition, since signals generated by the vibration of the AC of a single array element is fed back to other array elements, causing signal misjudgment, it is necessary to provide a resistor (for example, a 128 resistor) between the common DC and each CMUT array element, so that signals from the array element are correctly returned to the ADC of the system defined by the array element.

In summary, the current capacitive micromachined ultrasound transducer needs to provide the bias tee for each CMUT element, so the overall system volume is huge.

### SUMMARY

The disclosure provides an ultrasonic vibration sub-element and an ultrasound probe, which can reduce a system volume.

An embodiment of the disclosure provides an ultrasonic vibration sub-element, which includes a substrate, a ground layer, a first insulation layer, a second insulation layer, a first electrode layer, a third insulation layer, and a second electrode layer. The ground layer is disposed on the substrate. The ground layer is disposed between the substrate and the first insulation layer. The first insulation layer is disposed between the ground layer and the second insulation layer. The first electrode layer is configured to receive a direct current voltage. The second insulation layer is disposed between the first insulation layer and the first electrode layer. The first electrode layer is disposed between the second insulation layer and the third insulation layer. The second electrode layer is configured to receive an alternating current signal and is disposed between the second insulation layer and the third insulation layer. Before the ultrasonic vibration sub-element is driven, there is cavity between the first insulation layer and the second insulation layer. When the ultrasonic vibration sub-element is driven, the first electrode layer receives the direct current voltage and is configured to at least drive the second insulation layer to shrink toward the cavity. The second electrode layer receives the alternating current signal and is configured to at least drive the third insulation layer to vibrate.

An embodiment of the disclosure provides an ultrasound probe, which includes an ultrasonic transducer array and a control circuit. The ultrasonic transducer array is disposed in a housing and includes multiple transducers. The transducers are arranged in an array along an arrangement direction. Each transducer includes multiple ultrasonic vibration sub-elements. Each ultrasonic vibration sub-element includes a substrate, a ground layer, a first insulation layer, a second insulation layer, a first electrode layer, a third insulation layer, and a second electrode layer. The ground layer is disposed on the substrate. The ground layer is disposed between the substrate and the first insulation layer. The first insulation layer is disposed between the ground layer and the second insulation layer. The first electrode layer is configured to receive a direct current voltage. The second insulation layer is disposed between the first insulation layer and the first electrode layer. The first electrode layer is disposed between the second insulation layer and the third insulation layer. The second electrode layer is configured to receive an alternating current signal and is disposed between the second insulation layer and the third insulation layer. Before the ultrasonic vibration sub-element is driven, there is cavity between the first insulation layer and the second insulation layer. When the ultrasonic vibration sub-element is driven, the first electrode layer receives the direct current voltage and is configured to at least drive the second insulation layer to shrink toward the cavity. The second electrode layer receives the alternating current signal and is configured to at least drive the third insulation layer to vibrate. The control circuit is electrically connected to the ultrasonic transducer array and is configured to control the ultrasonic transducer array to receive and/or send a signal.

Based on the above, in the ultrasound probe or the ultrasonic vibration sub-element according to the embodiments of the disclosure, when the ultrasonic vibration sub-element is driven, the first electrode layer receives the direct current voltage and is configured to at least drive the second insulation layer to shrink toward the cavity, and the second electrode layer receives the alternating current signal and is configured to at least drive the third insulation layer to vibrate. Therefore, the design manner of separately providing the first electrode layer receiving the direct current voltage and the second electrode layer receiving the alternating current signal in the ultrasonic vibration sub-element does not require the use of a bias tee to drive the ultrasonic vibration sub-element, which can also reduce the voltage value of the direct current voltage in addition to further reducing the system volume.

### BRIEF DESCRIPTION OF THE DRAWINGS

FIG. 1 is a schematic view of an ultrasound probe according to an embodiment of the disclosure.

FIG. 2 is a schematic view of an ultrasonic transducer array in an ultrasound probe electrically connected to a first electrical connection strap and a second electrical connection strap according to an embodiment of the disclosure.

FIG. 3 is a schematic view of an ultrasonic transducer array in an ultrasound probe according to an embodiment of the disclosure.

FIG. 4A is a schematic cross-sectional view of an ultrasonic vibration sub-element according to a first embodiment of the disclosure.

FIG. 4B is a schematic cross-sectional view of another example of the ultrasonic vibration sub-element according to the first embodiment of the disclosure.

FIG. 5A to FIG. 5J are schematic views of a manufacturing process of the ultrasonic vibration sub-element in FIG. 4A.

FIG. 6 is a schematic view of the ultrasonic vibration sub-element in FIG. 4A being driven to vibrate.

FIG. 7A is a schematic top view of an ultrasonic vibration sub-element according to a second embodiment of the disclosure.

FIG. 7B is a schematic cross-sectional view of the ultrasonic vibration sub-element according to the second embodiment of the disclosure.

FIG. 8A to FIG. 8H are schematic views of a manufacturing process of the ultrasonic vibration sub-element in FIG. 7B.

FIG. 9 is a schematic view of the ultrasonic vibration sub-element in FIG. 7B being driven to vibrate.

FIG. 10 is a schematic top view of an ultrasonic vibration sub-element according to a third embodiment of the disclosure.

FIG. 11A and FIG. 11B are schematic views of a first electrode layer relative to a cavity in an ultrasonic vibration sub-element according to the disclosure.

FIG. 12 is a schematic view of a transducer in an ultrasonic transducer array of an ultrasound probe according to another embodiment of the disclosure.

FIG. 13 is a schematic view of a transducer in an ultrasonic transducer array of an ultrasound probe according to yet another embodiment of the disclosure.

FIG. 14 is a schematic view of a transducer in an ultrasonic transducer array of an ultrasound probe according to still another embodiment of the disclosure.

### DESCRIPTION OF THE EMBODIMENTS

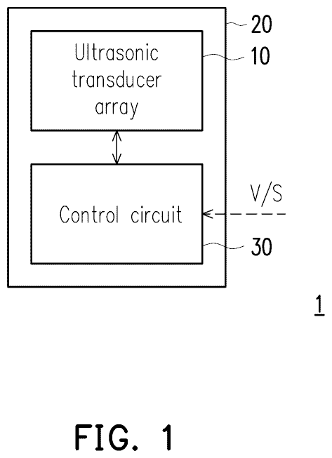

FIG. 1 is a schematic view of an ultrasound probe according to an embodiment of the disclosure. Please refer to FIG. 1. An embodiment of the disclosure provides an ultrasound probe 1, which includes a housing 20, an ultrasonic transducer array 10, and a control circuit 30. The ultrasonic transducer array 10 and the control circuit 30 are disposed in the housing 20. The control circuit 30 is electrically connected to the ultrasonic transducer array 10 and is configured to control the ultrasonic transducer array 10 to receive and/or send a signal.

In the embodiment, the control circuit 30 includes, for example, a microcontroller unit (MCU), a central processing unit (CPU), a microprocessor, a digital signal processor (DSP), a programmable controller, a programmable logic device (PLD), a multiplexer (MUX), a field programmable gate array (FPGA), an application specific integrated circuit (ASIC), other similar devices, or a combination of the devices, which is not limited by the disclosure. In addition, in an embodiment, each function of the control circuit 30 may be implemented by multiple program codes. The program codes are stored in a memory, and the program codes are executed by the control circuit 30. Alternatively, in an embodiment, each function of the control circuit 30 may be implemented by one or more circuits. The disclosure is not limited to using software or hardware to implement each function of the control circuit 30.

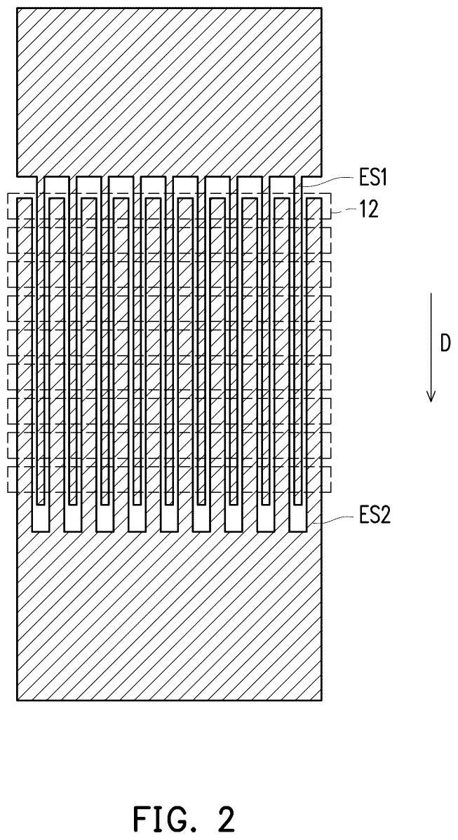

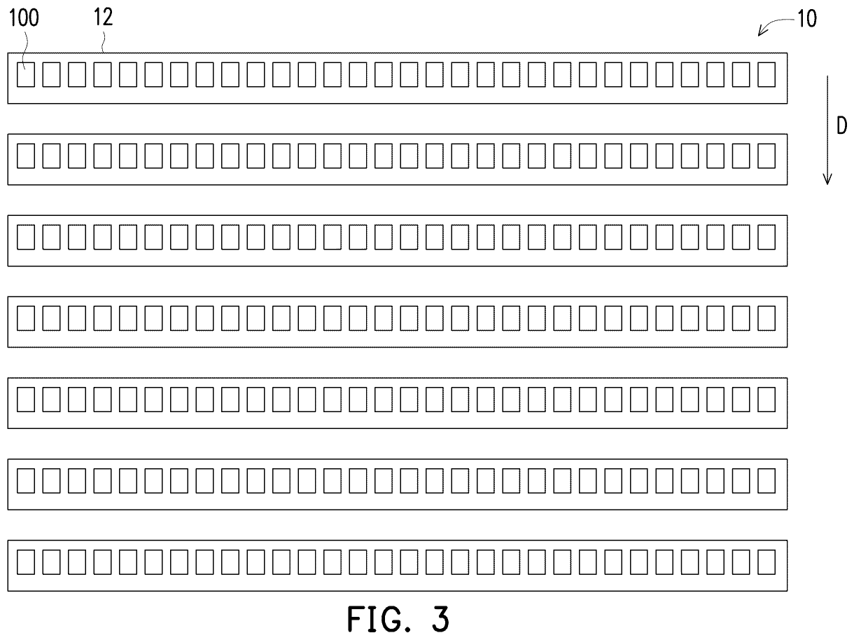

FIG. 2 is a schematic view of an ultrasonic transducer array in an ultrasound probe electrically connected to a first electrical connection strap and a second electrical connection strap according to an embodiment of the disclosure. FIG. 3 is a schematic view of an ultrasonic transducer array in an ultrasound probe according to an embodiment of the disclosure. Please refer to FIG. 2 and FIG. 3. In the embodiment, the ultrasonic transducer array 10 includes multiple transducers 12. The transducers 12 are arranged in an array along an arrangement direction D. Each transducer 12 includes multiple ultrasonic vibration sub-elements 100. The transducers 12 may be arranged in a one-dimensional or two-dimensional array. Each transducer 12 may be disposed on a plane (as shown in FIG. 3, FIG. 14, and FIG. 15) or a curved surface (as shown in FIG. 16), and the ultrasonic vibration sub-elements 100 in each transducer 12 may be arranged in a one-dimensional array (as shown in FIG. 3) or a two-dimensional matrix (as shown in FIG. 14 and FIG. 15).

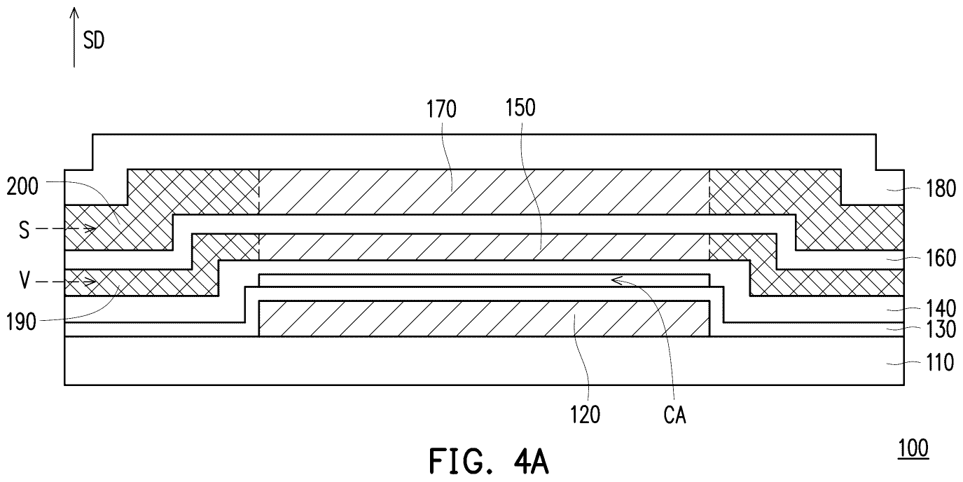

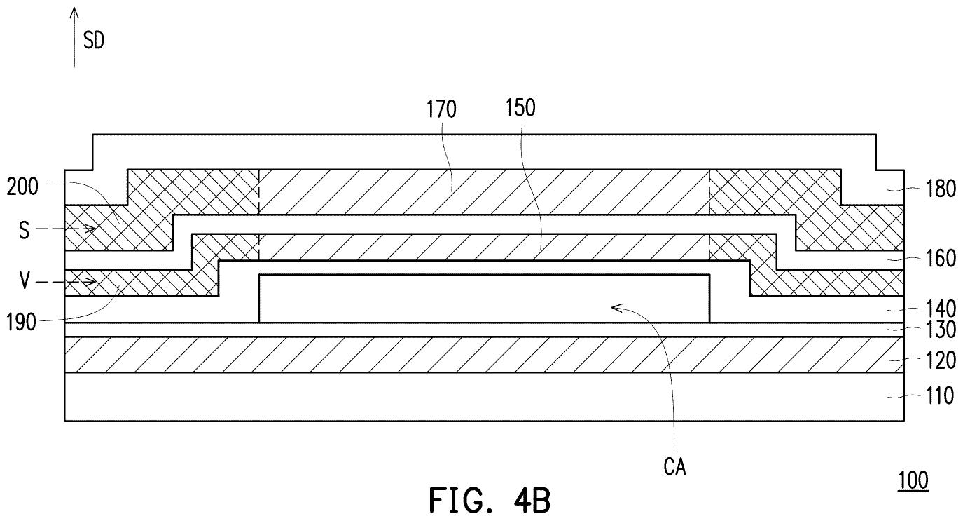

FIG. 4A is a schematic cross-sectional view of an ultrasonic vibration sub-element according to a first embodiment of the disclosure. FIG. 4B is a schematic cross-sectional view of another example of the ultrasonic vibration sub-element according to the first embodiment of the disclosure. Please refer to FIG. 4A and FIG. 4B. In the embodiment, each ultrasonic vibration sub-element 100 includes a substrate 110, a ground layer 120, a first insulation layer 130, a second insulation layer 140, a first electrode layer 150, a third insulation layer 180, and a second electrode layer 170. The material of the substrate 110 may be glass, silicon (Si), or silicon dioxide (SiO₂); the material of the ground layer 120, the first electrode layer 150, or the second electrode layer 170 may be aluminum (Al), indium tin oxide (ITO), copper (Cu), silver (Ag), or other conductive substances; the material of the first insulation layer 130, the second insulation layer 140, or the third insulation layer 180 may be silicon nitride, silicon oxide, or other insulation materials for protection, but the disclosure does not limit the material of each layer of the ultrasonic vibration sub-element 100. In the above embodiment, for the purpose of process convenience or electrical performance, the ground layers 120 of the ultrasonic vibration sub-elements 100 may be connected in series at the same time directly during the preparation of the ground layer 120, as shown in FIG. 4B.

In the embodiment, the ground layer 120 is disposed on the substrate 110 and is disposed between the substrate 110 and the first insulation layer 130. The first insulation layer 130 is disposed between the ground layer 120 and the second insulation layer 140. The second insulation layer 140 is disposed between the first insulation layer 130 and the first electrode 150 layer. The first electrode layer 150 is disposed between the second insulation layer 140 and the third insulation layer 180. The second electrode layer 170 is disposed between the second insulation layer 140 and the third insulation layer 180. The first electrode layer 150 is configured to receive a direct current voltage V. The second electrode layer 170 is configured to receive an alternating current signal S.

In the embodiment, the ultrasonic vibration sub-element 100 further includes a fourth insulation layer 160 disposed between the first electrode layer 150 and the second electrode layer 170. The material of the insulation layer 160 may be silicon nitride, silicon oxide, or other insulation materials for protection, but the disclosure does not limit the material of the insulation layer 160.

In the embodiment, the ultrasonic vibration sub-element 100 further includes a first lead pattern layer 190 disposed between the third insulation layer 180 and the second insulation layer 140. The first lead pattern layer 190 is electrically connected to the first electrode layer 150, and the first electrode layer 150 receives the direct current voltage V by the first lead pattern layer 190.

In the embodiment, the ultrasonic vibration sub-element further includes a second lead pattern layer 200 disposed between the second insulation layer 140 and the third insulation layer 180. The second lead pattern layer 200 is electrically connected to the second electrode layer 170, and the second layer electrode 170 receives the alternating current signal S by the second lead pattern layer 200. At least part of the first lead pattern layer 190 and at least part of the second lead pattern layer 200 are disposed on different planes perpendicular to a stacking direction SD. The stacking direction SD is a connection direction of the second insulation layer 140 and the third insulation layer 180.

In the embodiment, the first electrode layer 150 and the second electrode layer 170 are (respectively) disposed on a plane perpendicular to the stacking direction SD. When the first electrode layer 150 and the second electrode layer 170 are disposed on different planes perpendicular to the stacking direction SD, the fourth insulation layer 180 is disposed between the first electrode layer 150 and the second electrode layer 170.

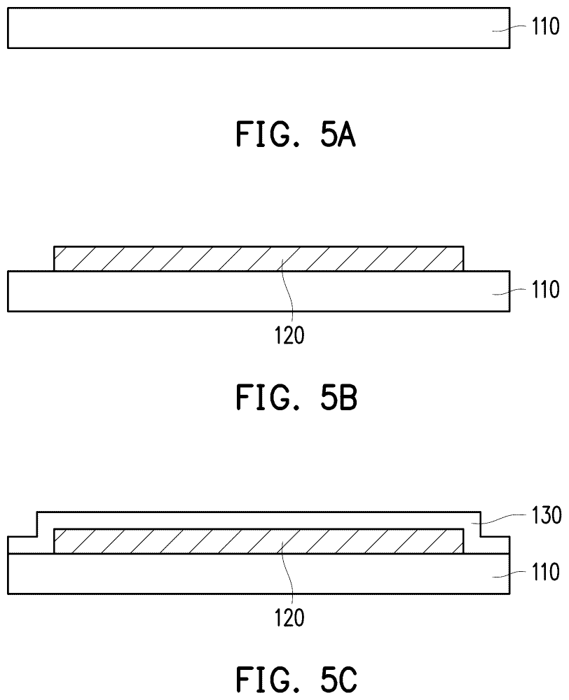

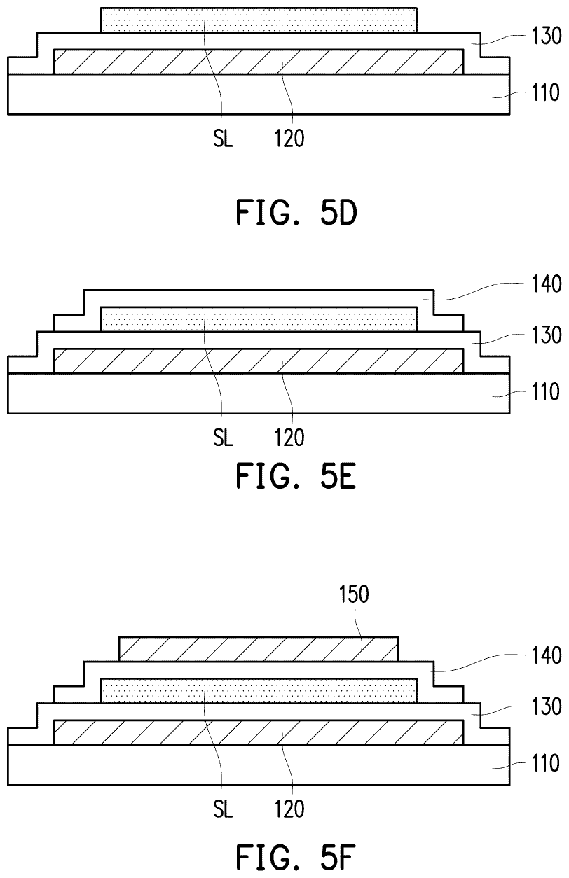

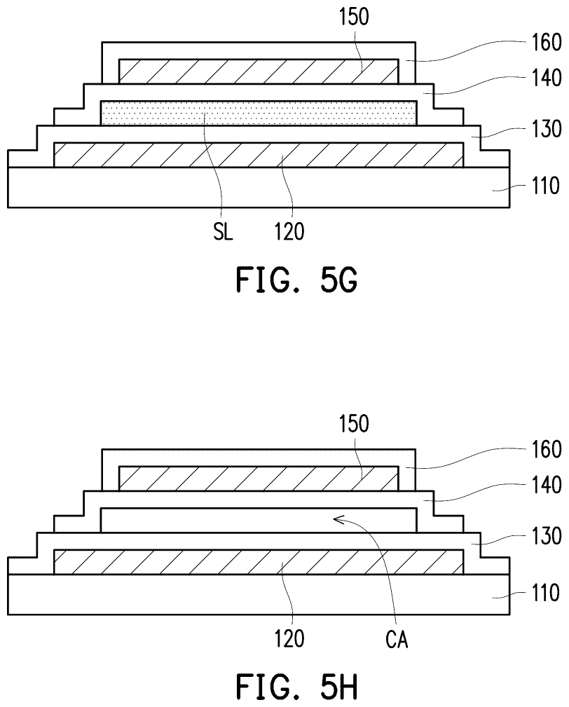

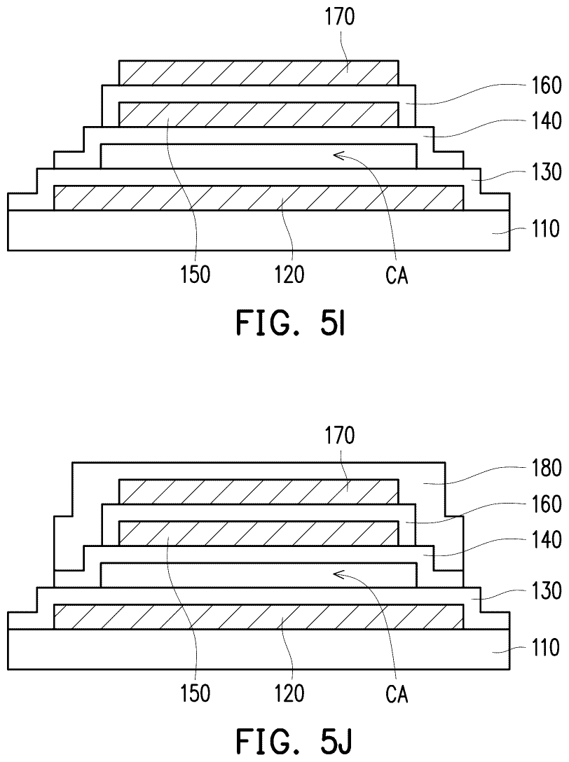

FIG. 5A to FIG. 5J are schematic views of a manufacturing process of the ultrasonic vibration sub-element in FIG. 4A. Please refer to FIG. 4A to FIG. 5J. In the embodiment, the manufacturing method of the ultrasonic vibration sub-element 100 includes the following steps. The ground layer 120 is formed on the substrate 110, as shown in FIG. 5A and FIG. 5B. The first insulation layer 130 is formed on the ground layer 120, as shown in FIG. 5C. A sacrificial layer SL is formed on the first insulation layer 130, as shown in FIG. 5D. The second insulation layer 140 is formed on the sacrificial layer SL, as shown in FIG. 5E. The first electrode layer 150 is formed on the second insulation layer 140, as shown in FIG. 5F. The fourth insulation layer 160 is formed on the first electrode layer 150, as shown in FIG. 5G. The sacrificial layer SL is removed to form a cavity CA between the first insulation layer 130 and the second insulation layer 140, as shown in FIG. 5H. Next, the second electrode layer 170 is formed on the fourth insulation layer 160, as shown in FIG. 5I. The third insulation layer 180 is formed on the second electrode layer 170 to form the ultrasonic vibration sub-element 100, as shown in FIG. 5J.

Please refer to FIG. 2 and FIG. 4A again. In the embodiment, the ultrasound probe 1 further includes multiple first electrical connection straps ES1 and multiple second electrical connection straps ES2. Each first electrical connection strap ES1 is electrically connected to the first electrode layer 150 of one of the ultrasonic vibration sub-elements 100 in each transducer 12, so that the first electrode layer 150 receives the direct current voltage V by the first electrical connection strap ES1. Each second electrical connection strap ES2 is electrically connected to the second electrode layer 170 of one of the ultrasonic vibration sub-elements 100 in each transducer 12, so that the second electrode layer 170 receives the alternating current signal S by the second electrical connection strap ES2. The first electrical connection straps ES1 and the second electrical connection straps ES2 are staggered, but the disclosure is not limited thereto.

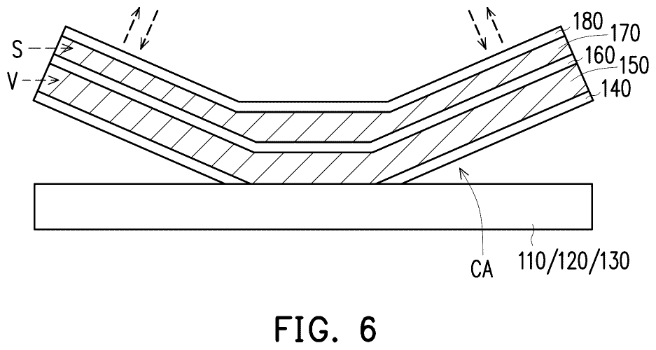

FIG. 6 is a schematic view of the ultrasonic vibration sub-element in FIG. 4A being driven to vibrate. In the embodiment, before the ultrasonic vibration sub-element 100 is driven, there is the cavity CA between the first insulation layer 130 and the second insulation layer 140. When the ultrasonic vibration sub-element 100 is driven, the first electrode layer 150 receives the direct current voltage V and is configured to at least drive the second insulation layer 140 to shrink toward the cavity CA. In the case where the second insulation layer 140 shrinks toward the cavity CA, a part of the second insulation layer 140 may touch the first insulation layer 130, or the second insulation layer 140 and the first insulation layer 130 still maintain a specific distance, but the disclosure is not limited thereto. The second electrode layer 170 receives the alternating current signal S and is configured to at least drive the third insulation layer 180 to vibrate, or the second electrode layer 170 itself successively drives the third insulation layer 180 to vibrate due to vibrations generated by the alternating current signal S, so as to generate sound waves. In addition, the second electrode layer 170 and the third insulation layer 180 may also be configured to receive sound wave signals from the outside, thereby generating vibrations and corresponding electrical signals.

In the embodiment, at least one of the first electrode layer 150 and the cavity CA is square or circular. In another embodiment, at least one of the first electrode layer 150 and the cavity CA may be polygonal.

Based on the above, in an embodiment of the disclosure, the ultrasound probe 1 or the ultrasonic vibration sub-element 100 includes the substrate 110, the ground layer 120, the first insulation layer 130, the second insulation layer 140, the first electrode layer 150, the third insulation layer 180, and the second electrode layer 170. The first electrode layer 150 is configured to receive the direct current voltage V. The second electrode layer 170 is configured to receive the alternating current signal S. When the ultrasonic vibration sub-element 100 is driven, the first electrode layer 150 receives the direct current voltage V and is configured to at least drive the second insulation layer 140 to shrink toward the cavity CA, and the second electrode layer 170 receives the alternating current signal S and is configured to at least drive the third insulation layer 180 to vibrate. Therefore, the design manner of separately providing the first electrode layer 150 receiving the direct current voltage V and the second electrode layer 170 receiving the alternating current signal S in the ultrasonic vibration sub-element 100 does not require the use of a bias tee to drive the ultrasonic vibration sub-element 100, which can also reduce the voltage value of the direct current voltage V in addition to further reducing the system volume. Moreover, since the system volume can be reduced, the application range is wide, such as being applied to a handheld ultrasound probe. Furthermore, the transducer 12 or the ultrasonic vibration sub-element 100 in the ultrasound probe 1 may be completed by adopting a panel process, a micro-electromechanical process, or a semiconductor process. Therefore, the manufacturing time and cost can be reduced, and mass production can be facilitated.

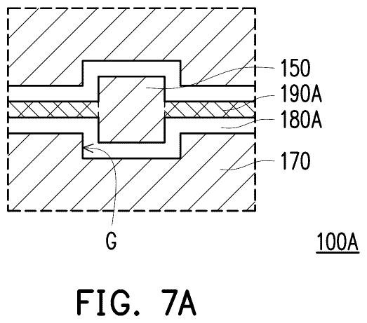

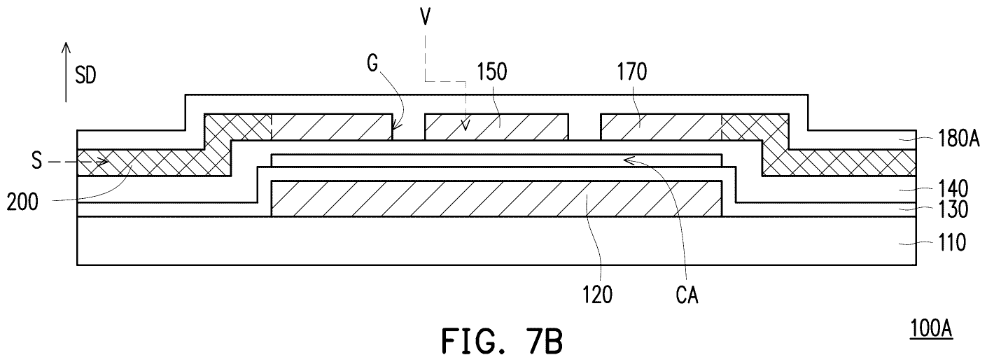

FIG. 7A is a schematic top view of an ultrasonic vibration sub-element according to a second embodiment of the disclosure. FIG. 7B is a schematic cross-sectional view of the ultrasonic vibration sub-element according to the second embodiment of the disclosure. Please refer to FIG. 7A and FIG. 7B. An ultrasonic vibration sub-element 100A is similar to the ultrasonic vibration sub-element 100 of FIG. 4A. The main difference is that in the embodiment, the first electrode layer 150, the second electrode layer 170, and a first lead pattern layer 190A is disposed on the same plane perpendicular to the stacking direction SD. Moreover, when the first electrode layer 150 and the second electrode layer 170 are disposed on the same plane perpendicular to the stacking direction SD, there is a gap G between the first electrode layer 150 and the second electrode layer 170. The gap G surrounds the first electrode layer 150, and at least part of the third insulation layer 180 is filled in the gap G.

In the embodiment, the pattern of the first lead pattern layer 190A is linear or cross-shaped, and in each transducer 12, the ultrasonic vibration sub-elements 100A are arranged in a one-dimensional array (as shown in FIG. 3).

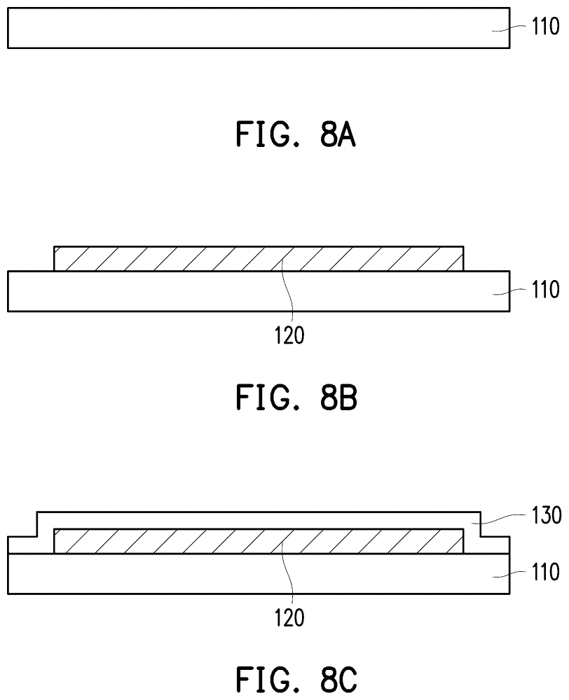

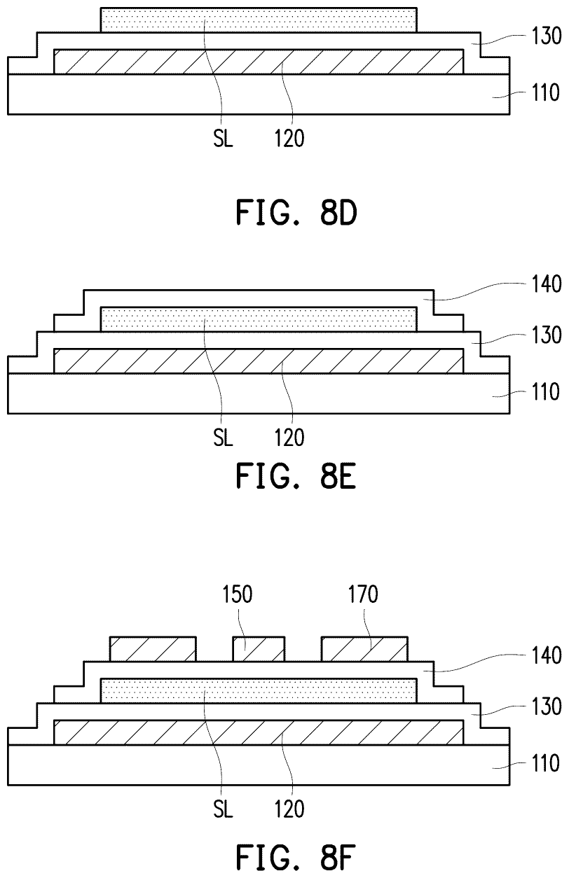

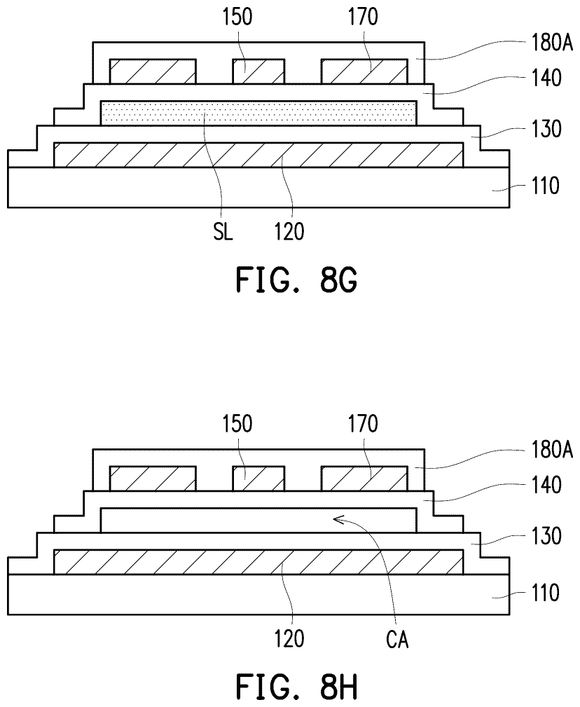

FIG. 8A to FIG. 8H are schematic views of a manufacturing process of the ultrasonic vibration sub-element in FIG. 7B. Please refer to FIG. 7B to FIG. 8H. In the embodiment, the manufacturing method of the ultrasonic vibration sub-element 100A includes the following steps. The ground layer 120 is formed on the substrate 110, as shown in FIG. 8A and FIG. 8B. The first insulation layer 130 is formed on the ground layer 120, as shown in FIG. 8C. The sacrificial layer SL is formed on the first insulation layer 130, as shown in FIG. 8D. The second insulation layer 140 is formed on the sacrificial layer SL, as shown in FIG. 8E. The (patterned) first electrode layer 150 and second electrode layer 170 are formed on the second insulation layer 140, as shown in FIG. 8F. A third insulation layer 180A is formed on the first electrode layer 150 and the second electrode layer 170, as shown in FIG. 8G. The sacrificial layer SL is removed to form the ultrasonic vibration sub-element 100A, as shown in FIG. 8H.

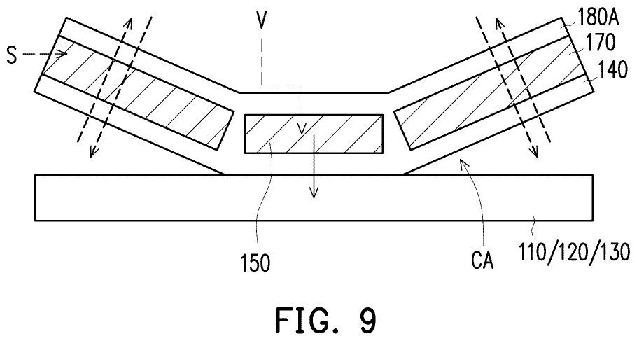

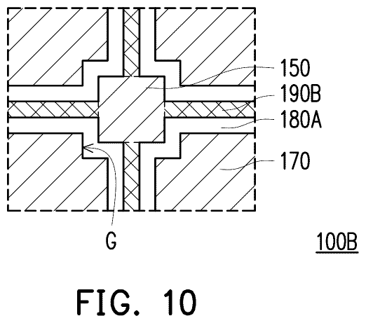

FIG. 9 is a schematic view of the ultrasonic vibration sub-element in FIG. 7B being driven to vibrate. Please refer to FIG. 9. The driving manners of the first electrode layer 150 of the ultrasonic vibration sub-element 100A receiving the direct current voltage V to at least drive the second insulation layer 140 to shrink toward the cavity CA and the second electrode layer 170 receiving the alternating current signal S to at least drive the third insulation layer 180 to vibrate are similar to the driving manners of the ultrasonic vibration sub-element 100 in FIG. 6 and will not be described again. In addition, since the first electrode layer 150 and the second electrode layer 170 are disposed on the same plane perpendicular to the stacking direction SD, when a panel process, a micro-electromechanical process, or a semiconductor process is adopted to manufacture the ultrasonic vibration sub-element 100A, the first electrode layer 150 and the second electrode layer 170 may be manufactured in one photomask process, as shown in FIG. 8F, thus further reducing the overall manufacturing time and production cost.

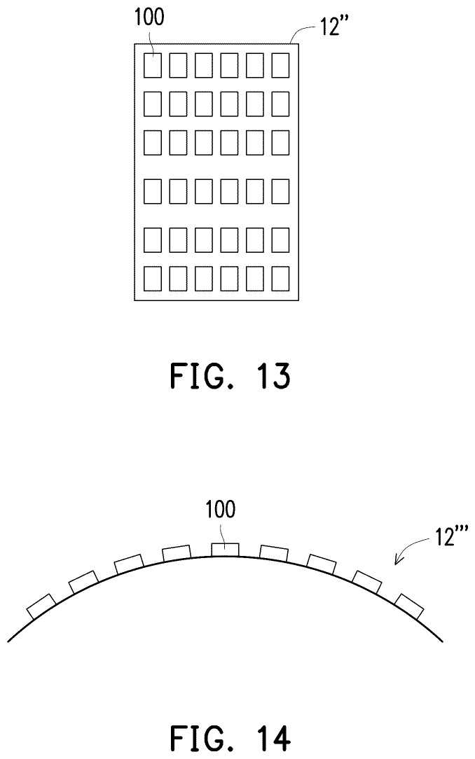

FIG. 10 is a schematic top view of an ultrasonic vibration sub-element according to a third embodiment of the disclosure. Please refer to FIG. 10. An ultrasonic vibration sub-element 100B is similar to the ultrasonic vibration sub-element 100A of FIG. 7A. The main difference is that in the embodiment, the pattern of a first lead pattern layer 190B is linear or cross-shaped, and in each transducer 12, the ultrasonic vibration sub-elements 100B are arranged in a two-dimensional matrix (as shown in FIG. 13).

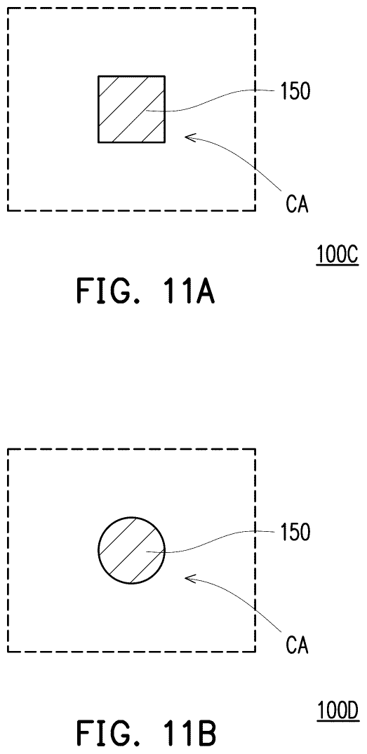

FIG. 11A and FIG. 11B are schematic views of a first electrode layer relative to a cavity in an ultrasonic vibration sub-element according to the disclosure. Please refer to FIG. 11A and FIG. 11B. In ultrasonic vibration sub-elements 100C and 100D, at least one of the first electrode layer 150 and the cavity CA is square (as shown in FIG. 11A) or circular (as shown in FIG. 11B), and the first electrode layer 150 is disposed at the center of the cavity CA.

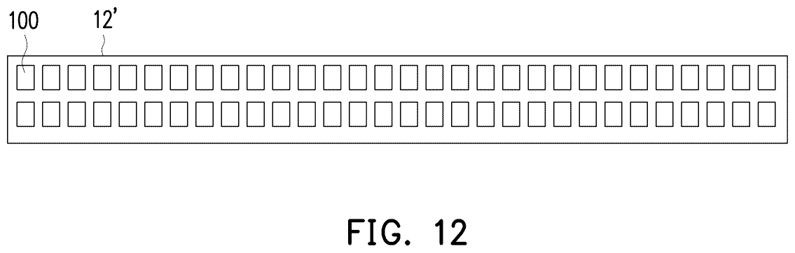

FIG. 12 is a schematic view of a transducer in an ultrasonic transducer array of an ultrasound probe according to another embodiment of the disclosure. Please refer to FIG. 12. A transducer 12′ is similar to the transducer 12 in FIG. 3. The main difference is that in the embodiment, in each transducer 12′, the ultrasonic vibration sub-elements 100 are arranged in a 2×n or n×2 matrix, where n≥2.

FIG. 13 is a schematic view of a transducer in an ultrasonic transducer array of an ultrasound probe according to yet another embodiment of the disclosure. Please refer to FIG. 13. A transducer 12″ is similar to the transducer 12 in FIG. 3 or the transducer 12′ in FIG. 12. The main difference is that in the embodiment, in each transducer 12″, the ultrasonic vibration sub-elements 100 are arranged in an n×m matrix, where m≥2 and n≥2.

FIG. 14 is a schematic view of a transducer in an ultrasonic transducer array of an ultrasound probe according to still another embodiment of the disclosure. Please refer to FIG. 14. A transducer 12′″ is similar to the transducer 12 in FIG. 3, the transducer 12′ in FIG. 12, or the transducer 12″ in FIG. 13. The main difference is that the ultrasonic vibration sub-elements 100 are arranged on a curved surface or the transducer 12′″ has a curved surface.

In summary, in the ultrasound probe or the ultrasonic vibration sub-element according to the embodiments of the disclosure, the first electrode layer is configured to receive the direct current voltage, and the second electrode layer is configured to receive the alternating current signal. When the ultrasonic vibration sub-element is driven, the first electrode layer receives the direct current voltage and is configured to at least drive the second insulation layer to shrink toward the cavity, and the second electrode layer receives the alternating current signal and is configured to at least drive the third insulation layer to vibrate. Therefore, the design manner of separately providing the first electrode layer receiving the direct current voltage and the second electrode layer receiving the alternating current signal in the ultrasonic vibration sub-element does not require the use of a bias tee to drive the ultrasonic vibration sub-element, which can also reduce the voltage value of the direct current voltage in addition to further reducing the system volume. Moreover, since the system volume can be reduced, the application range is wide, such as being applied to the handheld ultrasound probe. Furthermore, the transducer or the ultrasonic vibration sub-element in the ultrasound probe may be completed by adopting a semiconductor process, so the manufacturing time and cost can be reduced, and mass production can be facilitated.

What is claimed is:

1. An ultrasonic vibration sub-element, comprising:
a substrate;
a ground layer, disposed on the substrate;
a first insulation layer, wherein the ground layer is disposed between the substrate and the first insulation layer;
a second insulation layer, wherein the first insulation layer is disposed between the ground layer and the second insulation layer;
a first electrode layer, configured to receive a direct current voltage, wherein the second insulation layer is disposed between the first insulation layer and the first electrode layer;
a third insulation layer, wherein the first electrode layer is disposed between the second insulation layer and the third insulation layer; and
a second electrode layer, configured to receive an alternating current signal and disposed between the second insulation layer and the third insulation layer,
wherein before the ultrasonic vibration sub-element is driven, there is a cavity between the first insulation layer and the second insulation layer,
wherein when the ultrasonic vibration sub-element is driven, the first electrode layer receives the direct current voltage and is configured to at least drive the second insulation layer to shrink toward the cavity, and the second electrode layer receives the alternating current signal and is configured to at least drive the third insulation layer to vibrate.

2. The ultrasonic vibration sub-element according to claim 1, further comprising:
a fourth insulation layer, disposed between the first electrode layer and the second electrode layer.

3. The ultrasonic vibration sub-element according to claim 1, wherein at least one of the first electrode layer and the cavity is square or circular.

4. The ultrasonic vibration sub-element according to claim 1, further comprising:
a first lead pattern layer, disposed between the third insulation layer and the second insulation layer, wherein the first lead pattern layer is electrically connected to the first electrode layer, and the first electrode layer receives the direct current voltage by the first lead pattern layer.

5. The ultrasonic vibration sub-element according to claim 4, wherein a pattern of the first lead pattern layer is linear or cross-shaped.

6. The ultrasonic vibration sub-element according to claim 1, wherein the first electrode layer and the second electrode layer are disposed on a same plane perpendicular to a stacking direction, and the stacking direction is a connection direction of the second insulation layer and the third insulation layer.

7. The ultrasonic vibration sub-element according to claim 1, wherein the first electrode layer and the second electrode layer are disposed on a plane perpendicular to a stacking direction, and the stacking direction is a connection direction of the second insulation layer and the third insulation layer.

8. The ultrasonic vibration sub-element according to claim 7, wherein when the first electrode layer and the second electrode layer are disposed on a same plane perpendicular to the stacking direction, there is a gap between the first electrode layer and the second electrode layer, the gap surrounds the first electrode layer, and at least part of the third insulation layer is filled in the gap.

9. The ultrasonic vibration sub-element according to claim 7, wherein when the first electrode layer and the second electrode layer are disposed on different planes perpendicular to the stacking direction, a fourth insulation layer is disposed between the first electrode layer and the second electrode layer.

10. The ultrasonic vibration sub-element according to claim 9, further comprising:
a first lead pattern layer and a second lead pattern layer, wherein the first lead pattern layer is electrically connected to the first electrode layer, the second lead pattern layer is electrically connected to the second electrode layer, and at least part of the first lead pattern layer and at least part of the second lead pattern layer are disposed on the different planes perpendicular to the stacking direction.

11. An ultrasound probe, comprising:
an ultrasonic transducer array, disposed in a housing and comprising a plurality of transducers, wherein the transducers are arranged in an array along an arrangement direction, and each of the transducers comprises the ultrasonic vibration sub-elements according to claim 1; and
a control circuit, electrically connected to the ultrasonic transducer array and configured to control the ultrasonic transducer array to receive and/or send a signal.

12. The ultrasound probe according to claim 11, wherein each of the ultrasonic vibration sub-elements further comprises:
a fourth insulation layer, disposed between the first electrode layer and the second electrode layer.

13. The ultrasound probe according to claim 11, wherein at least one of the first electrode layer and the cavity is square or circular.

14. The ultrasound probe according to claim 11, wherein each of the ultrasonic vibration sub-elements further comprises:
a first lead pattern layer, disposed between the third insulation layer and the second insulation layer, wherein the first lead pattern layer is electrically connected to the first electrode layer, and the first electrode layer receives the direct current voltage by the first lead pattern layer.

15. The ultrasound probe according to claim 14, wherein the first electrode layer, the second electrode layer, and the first lead pattern layer are disposed on a same plane perpendicular to a stacking direction, and the stacking direction is a connection direction of the second insulation layer and the third insulation layer.

16. The ultrasound probe according to claim 14, wherein a pattern of the first lead pattern layer is linear or cross-shaped.

17. The ultrasound probe according to claim 11, wherein the first electrode layer and the second electrode layer are disposed on a plane perpendicular to a stacking direction, and the stacking direction is a connection direction of the second insulation layer and the third insulation layer.

18. The ultrasound probe according to claim 17, wherein when the first electrode layer and the second electrode layer are disposed on a same plane perpendicular to the stacking direction, there is a gap between the first electrode layer and the second electrode layer, the gap surrounds the first electrode layer, and at least part of the third insulation layer is filled in the gap.

19. The ultrasound probe according to claim 17, wherein when the first electrode layer and the second electrode layer are disposed on different planes perpendicular to the stacking direction, a fourth insulation layer is disposed between the first electrode layer and the second electrode layer.

20. The ultrasound probe according to claim 19, wherein each of the ultrasonic vibration sub-elements further comprises:
a first lead pattern layer and a second lead pattern layer, wherein the first lead pattern layer is electrically connected to the first electrode layer, the second lead pattern layer is electrically connected to the second electrode layer, and at least part of the first lead pattern layer and at least part of the second lead pattern layer are disposed on the different planes perpendicular to the stacking direction.
